(19) United States
(12) Patent Application Publication
(10) Pub. No.: US 2011/0103874 A1
(43) Pub. Date: May 5, 2011

(54) UNIVERSAL PENCIL MECHANISM

(76) Inventors: George Reekie, Birstol, RI (US); Nicholas M. Rosinski, Providence, RI (US); Kerry R. Nixon, Warwick, RI (US); Richard E. Paquet, Smithfield, RI (US); Richard M. Gagnon, Coventry, RI (US); Raymond Morgado, Swansea, MA (US); Frank Axel Torngren, Attleboro, MA (US)

(21) Appl. No.: 12/608,358

(22) Filed: Oct. 29, 2009

(51) Int. Cl. B43K 21/00

(52) U.S. Cl. 401/88; 401/99

(57) ABSTRACT

A pencil mechanism replaces a ballpoint pen refill and has an actuator for containing lead. A point of the mechanism is slidably mounted to the actuator and has a shoulder to engage a step in the pen when an end of the point projects from a writing end of the pen. The point has an open end for projecting the writing tip of the lead and a bushing for frictionally engaging the lead in the point to allow for, but resist axial movement of the lead. A point spring between actuator and point biases them apart and a clutch is slidably mounted to the actuator and point. The clutch has fingers for receiving lead and the actuator engages the clutch to close the fingers and fix the lead. Further forward movement of the actuator projects a writing tip of the lead from the pen as the shoulder engages the step to fix the writing tip in a writing position. The actuator is movable rearwardly for releasing the clutch and the lead and allowing the clutch to move rearwardly in the pen for a repeat of the lead feeding cycle.

### FIELD AND BACKGROUND OF THE INVENTION

The present invention relates generally to the field of writing instruments, and in particular, to a new and useful pencil mechanism in the form of a pencil cartridge that can be used to replace pen cartridges in pens that where not originally designed to accept anything other than the pen cartridge configured for that pen.

The Classic Century® ball point pen manufactured and sold by A. T. Cross Company or Lincoln, R.I., is a slim, stylish pen with a twist mechanism for extending and retracting the writing tip of its ballpoint pen refill cartridge that is specially configured for use in the pen. Although a mechanical pencil version of the Classic Century® writing instrument line is also available, the internal workings of the pencil are very different from these of the pen and they cannot share refill cartridges. Details about the internal mechanism of the Classic Century® pen are disclosed in U.S. Pat. No. 5,518,330 to Gervais et al., which is incorporated here by reference.

A mechanical pencil cartridge must have additional and different functionality over the functions required by a pen cartridge. For example, a pen cartridge must be extendable and retractable as a whole to expose the writing tip, since there is no relative movement between the writing tip and the rest of the cartridge. By contrast, a mechanical pencil cartridge must be capable of projecting the end of its length of writing lead beyond the end of the cartridge itself, and also beyond the end of the writing instrument barrel, to permit writing and to protect the tip. In addition, there must be some way of holding the lead fixed in the cartridge for writing, to avoid simply pushing the writing tip back into the cartridge upon pressing the tip to paper. This fixing mechanism must be releaseable, however, to allow the writing tip of the lead to be pushed back into the cartridge when not in use so the instrument and be stored, e.g. in a pocket. Further, the mechanism must be able to cycle new lead out from the tip as the lead is used up and again to allow for alternate fixing of the lead for writing, and releasing of the lead for its retraction into the cartridge for storage.

It would be a feat to create a mechanical pencil cartridge that can be used in a pen mechanism that was not originally design for it, while extracting all of the different and additional functions needed for a mechanical pencil cartridge from the original pen mechanism.

### SUMMARY OF THE INVENTION

It is an object of the present invention to provide a mechanical pencil mechanism or replacement cartridge that is interchangeable with a ballpoint refill produced by Cross or others, without having to change or adapt the existing pen mechanism in any way. The pencil mechanism or replacement cartridge of the invention can be inserted in a pen body in place of the refill, wherein a twist action that propels and repels the writing point will serve to propel the pencil lead from the tip of the pencil mechanism as well as propelling the writing tip or point.

Another object of the invention is to provide such a mechanism that will work in many of Cross' ballpoint pens and does not require specific extra functionality, thereby making it backward compatible to existing pens.

A still further object of the invention is to provide a pencil mechanism that replaces a ballpoint pen refill and has an actuator for containing lead with a point that is slidably mounted to the actuator and has a shoulder to engage a step in the pen when an end of the point projects from a writing end of the pen, the point having an open end for projecting the writing tip of the lead and a bushing for frictionally engaging the lead in the point to allow for, but at the same time resist, axial movement of the lead. A point spring is between the actuator and the point and biases them apart and a clutch is slidably mounted to the actuator and point. The clutch has fingers for receiving lead and the actuator engages the clutch to close the fingers and fix the lead. Further forward movement of the actuator projects the writing tip of the lead from the pen as the shoulder engages the step to fix the writing tip in a writing position. The actuator is movable rearwardly for releasing the clutch and the lead and allowing the clutch to move rearwardly in the pen for a repeat of the lead feeding cycle.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a side elevational view, partly in section of a universal pencil mechanism of the invention;

FIG. 2 is an enlarged sectional view a point assembly of the invention;

FIG. 3 is an exploded view of the point assembly;

FIG. 4 is view similar to FIG. 1 but without the point assembly;

FIG. 5 is a view similar to FIG. 2 shown in a rest position but with an actuator tube of the invention and with a length of writing lead in place and ready for the start of a lead feeding cycle;

FIG. 6 is a view similar to FIG. 2, showing an initial movement of an actuator subassembly of the invention just after the rest position of FIG. 5, for clutching the lead in preparation for feeding;

FIGS. 7 to 14 are views similar to FIG. 6 showing respectively in sequence, the lead feeding cycle and its repetition;

FIG. 15 is a side elevational view, partly in section of the universal pencil mechanism of the invention, inside a pen that was designed for a ballpoint pen refill but which can successfully operate the pencil mechanism of the invention with no alteration of the pen;

FIG. 16 is a view similar to FIG. 5, but of a second embodiment of the invention; and

FIG. 17 is a view similar to FIG. 7, but of the second embodiment of the invention.

### DESCRIPTION OF THE PREFERRED EMBODIMENTS

The universal pencil mechanism of the invention allows the lead in the mechanism to be held tight for use in the protracted position without having to spring back the mechanism. This means that the preexisting ballpoint pen mechanism for driving the pencil mechanism does not have to have a spring back function. The mechanism allows that the lead is not gripped during repel or at fully retracted position. In known lead feeding mechanisms the lead would be locked in the retracted position. This allows the lead to be manually pushed back into the pen in any retracted position.

This functionality is accomplished by the use of a drag bushing that provides force in the opposite direction of the movement of a clutch to cause the clutch to grip or release. Other mechanisms use a combination of stops and springs to provide a grip/release force.

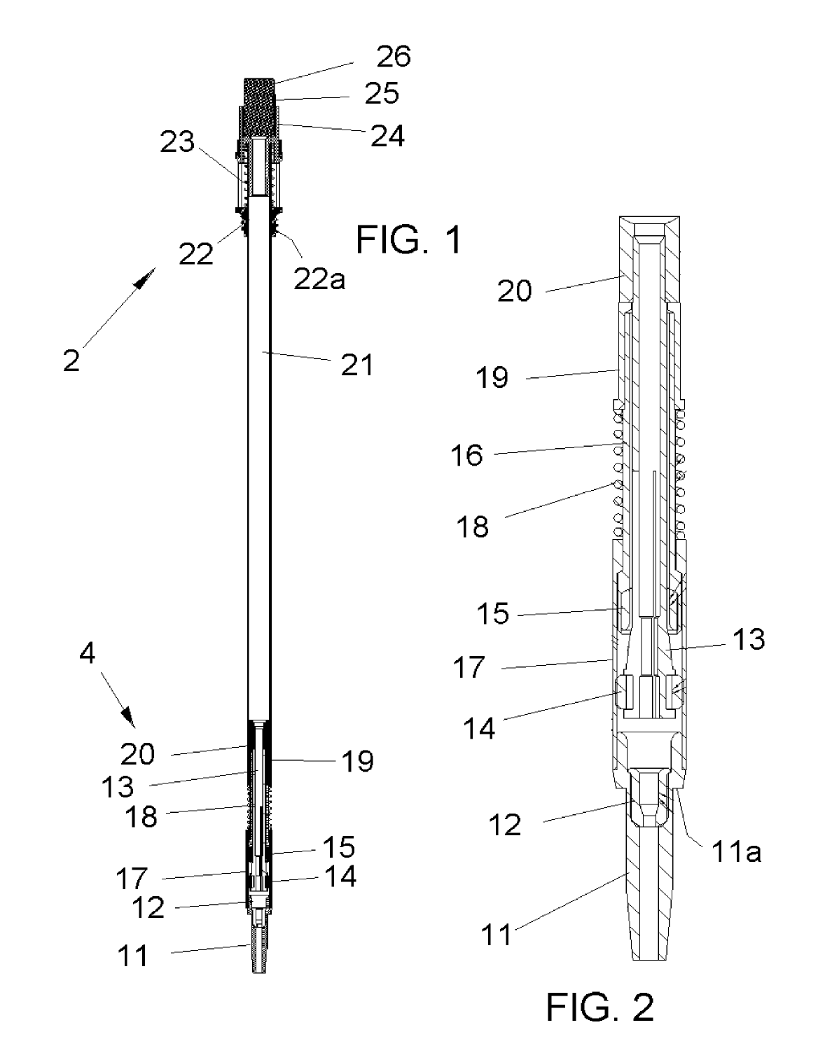

Referring now to the drawings, in which like reference numerals are used to refer to the same or similar elements, FIG. 1 shows a preferred embodiment do the invention to comprise a body assembly 2 and a point assembly 4, which are fixedly attached to each other by a hollow lead storage tube 21.

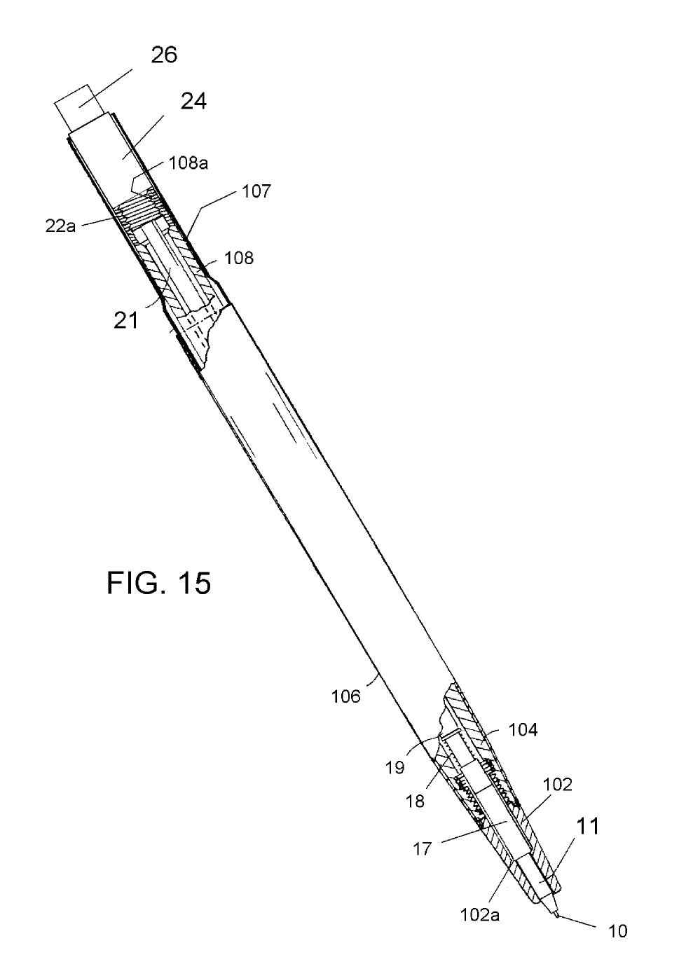

With reference now to FIG. 15, that illustrates a twist pen mechanism for ballpoint pen refills as also disclosed in U.S. Pat. No. 5,518,330, the mechanism of the invention is connected to the ballpoint twist mechanism by male threads 22a on a pencil top 22 that mate with a female thread 108a in an axially movable shuttle 108 of the twist pen mechanism. These threads transmit axial force from the pen mechanism to the pencil mechanism as a rear pen barrel (not shown) that is press fit over a driver 107 of the prior Cross twist pen mechanism is rotated with respect to a front barrel 106 of the pen. A helical drive mechanism in the pen that is fully disclosed in U.S. Pat. No. 5,518,330, causes the resulting axial motion of the entire pencil mechanism in the pen. An anchor bushing 104 fixed inside the front barrel 106 is also fixed by a treaded and glued front outer pen casing 102 which importantly, has an inner annular step 102a against which a front shoulder 11a of a point 11 of the pencil mechanism rests in an extended writing position of the invention.

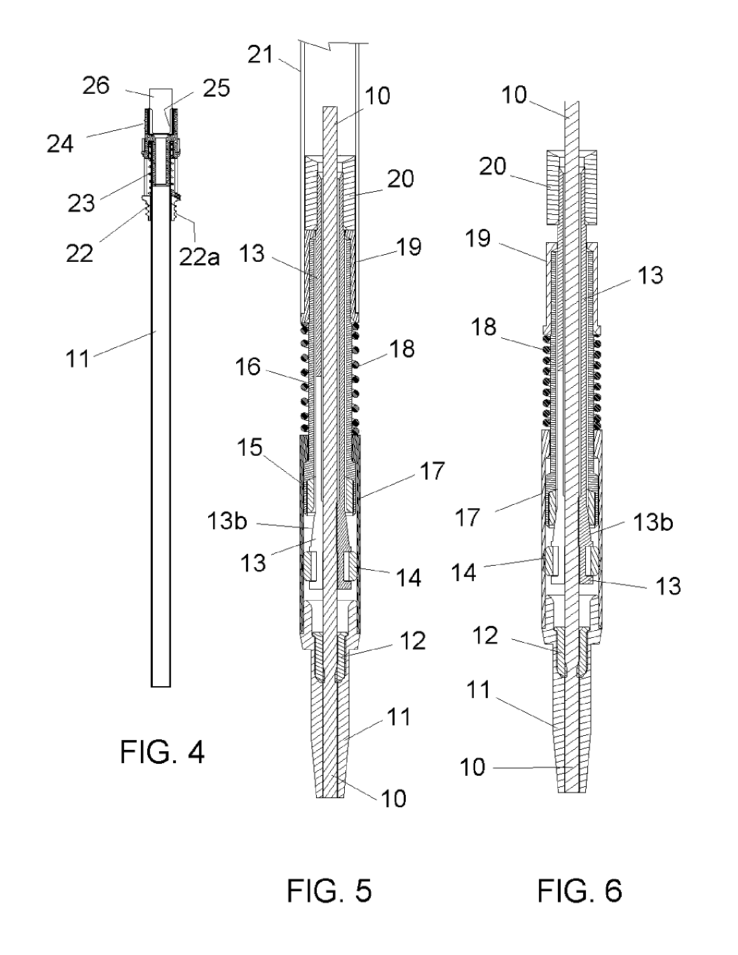

With reference now to FIGS. 1, 4 and 15, a sliding connection between the pencil top 22 and an eraser holder 24 allows the user to pump the pencil mechanism directly by pushing down on an eraser 26 that is press fit into the eraser holder 24 and held fast by an eraser ferrule 25 made of soft metal and bent around a bottom of the eraser 26. A top spring 23 biases the eraser 26 rearwardly or upwardly in the figures, and disengages the pencil mechanism when force on the eraser holder 24 is removed as will be explained later in this disclosure.

Axial force is transmitted from the pencil top 22 of the body assembly 2 by the tube 21 to the point assembly 4. The hollow tube 21 also holds spare leads shown at 10 in FIGS. 5 to 15. Leads 10 can be loaded from the point or from a through-hole in the axial center of the eraser holder 24 that is accessed by removing the eraser 26.

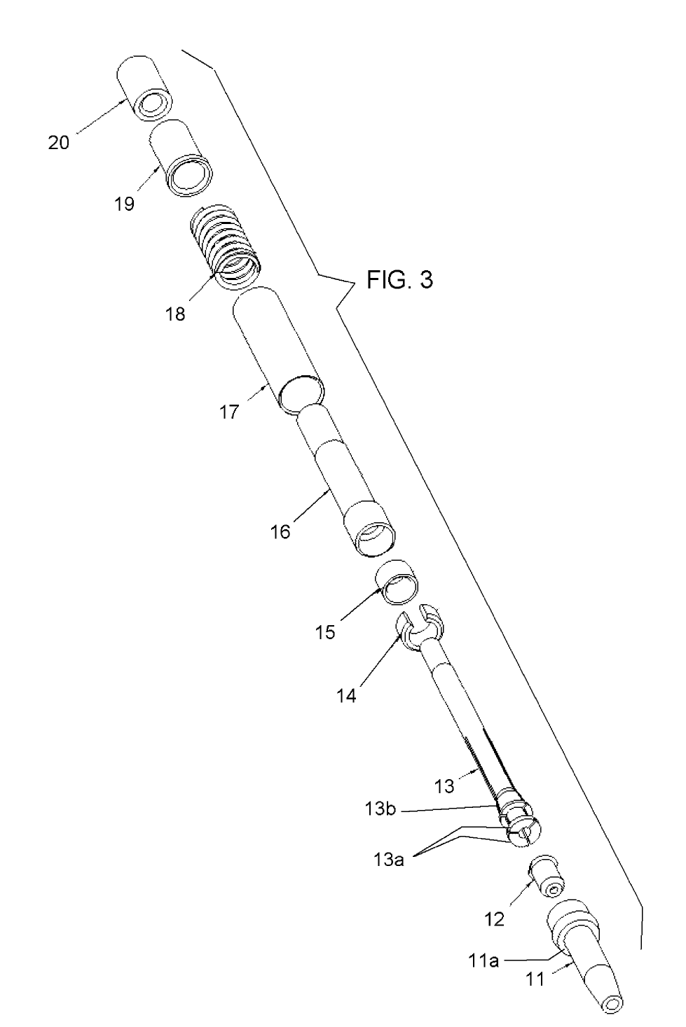

Referring to FIGS. 2, 3 and 5, the tube 21 is fixedly connected to a actuator 16 via a tube bushing 19. A point body 17 is fixedly connected to the point 11 and a point insert 12 made of resilient, high friction material like rubber, that also functions as a point bushing to hold the lead 10 by friction, is fixedly connected to the point 11 such that it provides an axial drag force on the lead 10. This point subassembly made up of point 11, insert 12, and point body 17, is slidably connected to an actuator subassembly made up of actuator 16, an actuator insert 15 and the tube 21, and is biased away from the tube 21 by a point spring 18. A clutch 13, e.g. made of resilient material such as brass, is contained inside the point subassembly 11, 12, 17 and inside the actuator subassembly 15, 16, 21, so that the clutch 13 can move axially independently of either subassembly. Actuator insert 15 is made of low friction plastic and is fixed in a forward end of actuator 16 that itself is made of metal, e.g. aluminum, steel or brass.

A clutch adaptor 20 is fixedly attached to the rear or top end of the clutch 13 to prevent the actuator subassembly 15, 16, 21 from separating from the clutch subassembly 13, 20. The clutch subassembly also includes a drag bushing 14 in the form of a springy spit plastic ring, attached around three axially extending and circumferentially spaced lead clutching fingers 13a of the clutch 13 such that drag bushing 14 drags against an inside surface of the point body 17 thereby providing an axial force to the clutch 13 in the opposite direction of the motion of the clutch but still allowing the clutch fingers 13a to open or close. The drag bushing 14 may alternatively be star shaped, oval or some other form than split as long as it can frictionally engage the point body surface to resist, but allow, axial motion.

Twisting the driver 107 of the pen mechanism shown in FIG. 15, in a manner that would move the shuttle 108 axially to propel a ballpoint refill forwardly, causes the pencil mechanism to be propelled forwardly or downwardly in the figures, until the point shoulder 11a bottoms out on the pen point step or shelf 102a and the front of point 11 with a writing tip of lead 10 is exposed by extending out from the open writing end of the front pen casing 102 of the pen barrel 106. The point 11 has a channel with an open end for receiving the writing tip of the lead 10 in the point subassembly. Continued twisting of driver 107 moves the tube 21 further forward relative to the point 11 thereby compressing the spring 18. This movement and initial compression of point spring 18 is illustrated as the movement from FIG. 5 to FIG. 6.

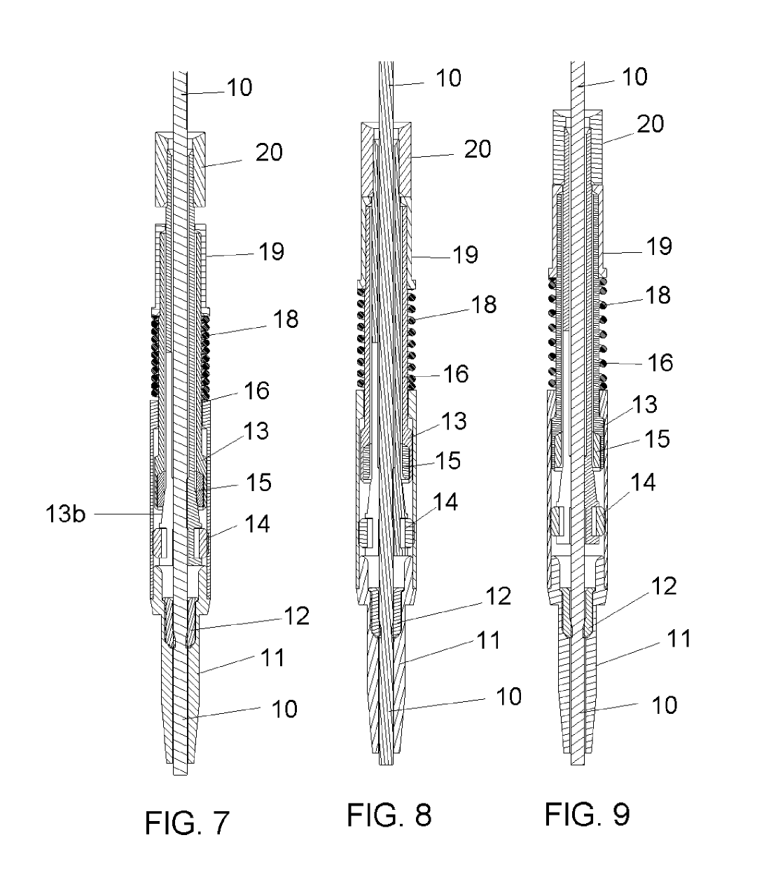

The tube 21 moving forward relative to the point 11 causes the actuator 16 to move forwardly inside the point body 17 as well. Actuator insert 15 of actuator 16 first engages the outer inclined surface 13b of the clutch fingers 13a and moves the clutch 13 forwardly. The reacting axial force provided by the drag bushing 14 pushes the clutch fingers 13a into the plastic insert 15 of actuator 16, causing them to close by taper lock action thus gripping the lead 10 with a force greater than that provided by the point bushing/insert 12. The force of the actuator 16 pushing on the clutch 13 then overcomes the force of the drag bushing 14 causing the clutch 13 to move forward and advance the lead 10 for the remaining throw of the actuator as sequentially shown in FIGS. 7 and 8 respectively.

The clutch 13 bottoms out on the inside of the point 11 and the force provided by the pen mechanism via the tube 21 creates a reactive force from the point 11 pushing the clutch fingers 13a into the actuator 16 thus locking the lead 10 in a useable position.

A rearward axial motion of the tube 21 actuated by twisting the driver 107 of the pen mechanism in the opposite retract direction (FIG. 9) causes the actuator 16 to move rearwardly. The point subassembly 11, 12, 17 is forced to stay forward relative to the actuator by the bias of the point spring 18. The drag bushing 14 provides a force to the clutch 13 in the opposite direction of the actuator motion thus releasing the clutch 13 from the actuator 16, in particular to allow the low friction plastic insert 15 to slide back off the inclined surfaces 13b, and allowing the clutch fingers 13a to spring open thus releasing the lead 10. The lead 10 is held still by friction force applied by the point bushing 12. The tube bushing 19 encounters the clutch adapter 20 providing an axial force rearward to the clutch subassembly which is greater than the force of the drag bushing 14 such that the clutch 13 moves rearward relative to the lead 10 for the rest of the actuators throw.

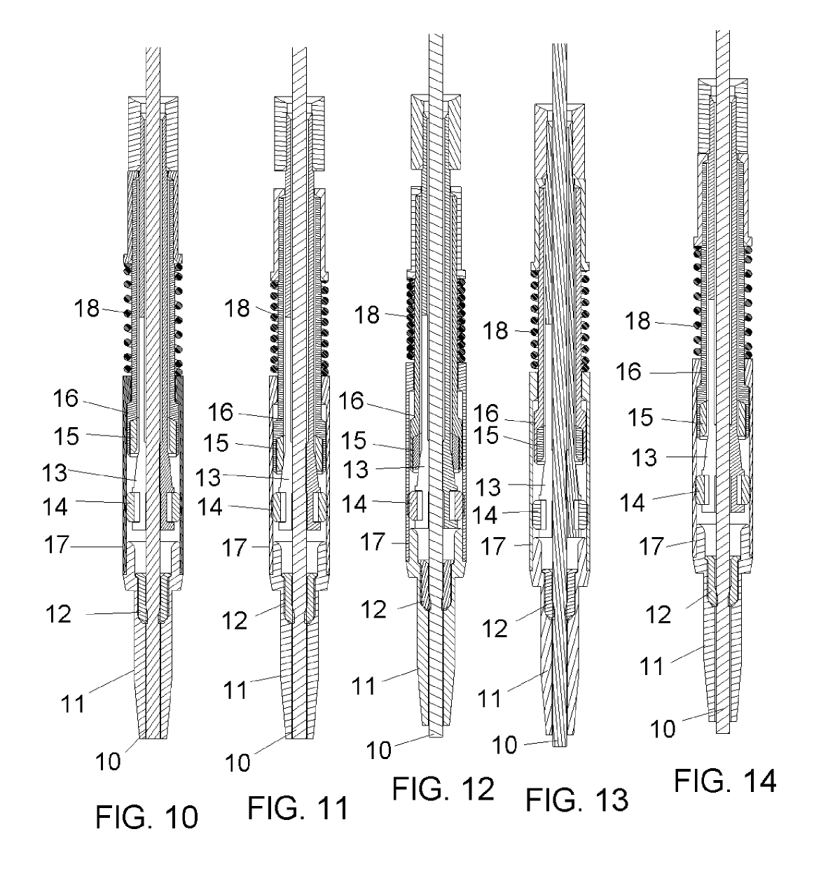

The point body bottoms out on the actuator restraining further axial motion between adaptor subassembly and the point subassembly such that continued rearward motion of the pen mechanism repels the whole pencil mechanism until the pen mechanism bottoms out and the point is retracted (FIG. 10).

Repeated axial thrusts (FIGS. 11 to 14) from the clutch via the actuator will provide for continuous advancement of the lead. In any retracted position after the clutch disengages, the lead 10 will be free to be pushed manually back into the mechanism by overcoming the force of the point insert or bushing 12.

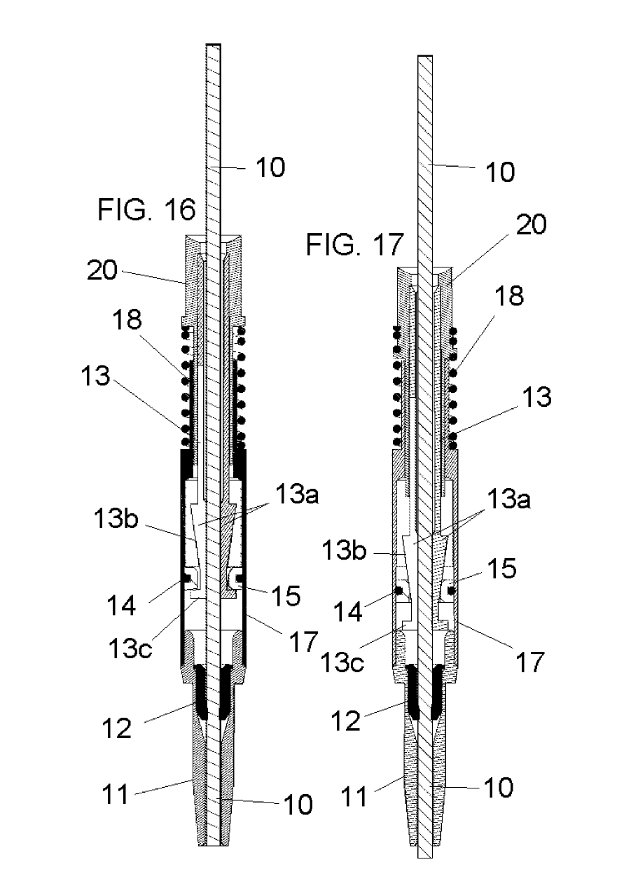

Referring now to FIGS. 16 and 17 which illustrate and second embodiment of the invention, the same reference numerals are used to designate functionally similar parts as in the embodiment illustrated in FIGS. 2 to 14. The difference is that in FIGS. 16 and 17, the clutch 13 is connected to or made as one piece with the tube bushing 20 and is therefore fixed to the actuator of the pencil mechanism, while the actuator insert 15 is frictionally engaged by drag bushing 14 extending around the actuator insert 15, against the slidable surface of point body 17, so that the insert 15 can slide axially, but with resistance, inside the point body 17. Actuator insert 15 has an inner low friction surface that can ride up inclined surfaces 13b of clutch 13, which, in FIGS. 16 and 17, are inclined in an opposite direction from surfaces 13b in FIGS. 2 to 14, to close the clutch fingers 13a on the lead 10 so in can be fed downwardly and locked as in FIG. 17. This occurs when the tube 21 of FIG. 5, not shown in FIGS. 16 and 17 but fixed to actuator bushing 20, is moved downwardly by rotation of the pen driver 107 in FIG. 15. In the rest position of FIG. 16, a stop 13c on the lower end of each clutch finger 13a, traps insert 15 with clutch 13 so upward movement of the clutch by action of point spring 18, also raises the insert 15 in the point body 17 in preparation for the next lead feeding cycle.

For convenience and ease of reference, following is a component list by reference numeral, illustrated in the drawings: 2 body assembly; 4 point assembly; 10 lead; 11 point; 12 point bushing; 13 clutch; 14 drag bushing; 15 actuator insert; 16 actuator; 17 point body; 18 point spring; 19 tube bushing; 20 clutch adaptor; 21 tube; 22 pencil top; 13 top spring; 24 eraser holder; 25 eraser ferrule; 26 eraser; 101 front outer pen casing; 104 anchor busing; 106 front barrel; 107 driver; and 108 shuttle.

Advantages of the invention include the fact that the pencil mechanism of the present invention is interchangeable with ballpoint refills, allowing a single writing instrument to change functions between ballpoint pen and pencil. The mechanism will work in the existing Cross helical drive ballpoint pens and does not require specific extra functionality added to the pen mechanism thereby making it backward compatible to these existing pens. Interchangeability between pen and pencil will reduce the number of different assemblies to be manufactured but still provide pencil and pen functions to the customer. The lead can be manually pushed back into the mechanism in the retracted position. The operation of the mechanism is similar to the operation of other Cross ballpoint pen products.

Currently brass, plastic and rubber components are used but any of these materials could be switched to achieve comparable results.

While specific embodiments of the invention have been shown and described in detail to illustrate the application of the principles of the invention, it will be understood that the invention may be embodied otherwise without departing from such principles.

What is claimed is:

1. A pencil mechanism for replacing a pen refill in a pen having a driver rotatably connected to a barrel for moving a shuttle axially in the barrel, the barrel having an open writing end with a step near the open writing end, the pencil mechanism comprising:
an actuator subassembly including hollow tube for containing at least one lead having a writing tip, the tube being adapted to be connected to the shuttle for axial movement in the pen when the driver is rotated with respect to the barrel;
a point subassembly slidably mounted to the actuator subassembly and having a point with a shoulder adapted to engage the step when an end of the point projects from the writing end of the pen, the point also having a channel with an open end for receiving the writing tip of a lead in the point subassembly, the point subassembly including a point bushing for frictionally engaging lead in the point subassembly to allow but resist axial relative movement between the lead and the point subassembly;
a point spring engaged between the actuator subassembly and the point subassembly for biasing the point subassembly forwardly and the actuator subassembly rearwardly in the pen; and
a clutch subassembly slidably mounted to the point subassembly, the clutch subassembly including a clutch with plurality of resilient fingers for receiving lead, the resilient fingers having inclined surfaces, the actuator subassembly moving the clutch subassembly forwardly by rotation of the driver in a first direction, the actuator subassembly including an actuator insert for riding along the inclined surfaces for close the fingers to engage lead in the clutch to fix the lead with respect to the clutch so that further forward movement of the actuator subassembly projects a writing tip of the lead from the open end of the point while the shoulder is engaged against the step to fix the writing tip in a writing position and compete a lead feeding cycle;
the actuator subassembly being movable rearwardly in the pen by rotation of the driver in an opposite second direction for releasing the actuator insert for the inclined surfaces to open the fingers to disengage the lead and allow the clutch subassembly to move rearwardly in the pen, the lead being frictionally held by the point bushing but being moveable into the point by pressure exerted again the frictional holding, to allow for a repeat of the lead feeding cycle.

2. The pencil mechanism of claim 1, wherein the clutch subassembly is slidably mounted with respect to the actuator subassembly and has a clutch adaptor opposite from the clutch fingers and engageable against the actuator subassembly for restricting relative axial movement between the actuator and the clutch subassemblies, the actuator subassembly being movable rearwardly in the pen by rotation of the driver in an opposite second direction for releasing the actuator from the clutch to release the clutch fingers from the lead and allow the clutch subassembly to move rearwardly in the pen, the lead being frictionally held by the point bushing but being moveable into the point by pressure exerted again the frictional holding, continued rearward movement of the actuator subassembly causing engagement with the clutch adaptor for causing rearward movement of the clutch subassembly with respect to the point subassembly and the lead that is frictionally held by the point bushing, to allow for a repeat of the lead feeding cycle. the actuator from the clutch to release the clutch fingers from the lead.

3. The pencil mechanism of claim 1, wherein the clutch subassembly is fixed to the actuator subassembly except that the actuator insert is fictionally slidably to the point subassembly, the clutch subassembly having a stop at each clutch finger for moving the actuator insert rearwardly with the clutch after the actuator insert slides of the inclined surfaces.

4. The pencil mechanism of claim 1, wherein the clutch subassembly includes a drag bushing for frictionally engaging the point subassembly to resist sliding between the clutch and point subassemblies but by an amount that is less than a bias of the point spring so that when the clutch subassembly is moved rearwardly it slides rearwardly with respect to the point subassembly.

5. The pencil mechanism of claim 1, wherein the clutch includes a plurality of inclined surfaces facing the actuator, the actuator subassembly including an insert of low friction material connected to the actuator for engaging and sliding along the inclined surfaces to close and open the clutch fingers on the lead.

6. The pencil mechanism of claim 1, wherein the clutch subassembly includes a drag bushing for frictionally engaging the point subassembly to resist sliding between the clutch and point subassemblies but by an amount that is less than a bias of the point spring so that when the clutch subassembly is moved rearwardly it slides rearwardly with respect to the point subassembly, the clutch including a plurality of inclined surfaces facing the actuator, the actuator subassembly including an insert of low friction material connected to the actuator for engaging and sliding along the inclined surfaces to close and open the clutch fingers on the lead.

7. The pencil mechanism of claim 1, including a body assembly connected to an end of the tube of the actuator subassembly that is opposite for the point, the body assembly including an eraser holder fixed to the tube and adapted to receive an eraser, and a pencil top slidably connected to the eraser holder and including a thread adapted for connecting the pencil mechanism to the shuttle of the pen, the body assembly also including a top spring for biasing the eraser holder rearwardly so that pressing forwardly on the eraser holder moved the tube forwardly against the bias of the top spring to cause a lead feeding cycle without rotation of the driver.

8. The pencil mechanism of claim 1, including a body assembly connected to an end of the tube of the actuator subassembly that is opposite for the point, the body assembly including an eraser holder fixed to the tube and adapted to receive an eraser, and a pencil top slidably connected to the eraser holder and including a thread adapted for connecting the pencil mechanism to the shuttle of the pen, the body assembly also including a top spring for biasing the eraser holder rearwardly so that pressing forwardly on the eraser holder moved the tube forwardly against the bias of the top spring to cause a lead feeding cycle without rotation of the driver, and wherein the clutch subassembly includes a drag bushing for frictionally engaging the point subassembly to resist sliding between the clutch and point subassemblies but by an amount that is less than a bias of the point spring so that when the clutch subassembly is moved rearwardly it slides rearwardly with respect to the point subassembly, the clutch including a plurality of inclined surfaces facing the actuator, the actuator subassembly including an insert of low friction material connected to the actuator for engaging and sliding along the inclined surfaces to close and open the clutch fingers on the lead.

9. A pencil mechanism comprising:
an actuator subassembly (20) including a hollow tube for containing at least one lead having a writing tip, the tube being adapted to be connected to a shuttle for axial movement in a pen when a driver is rotated with respect to a pen barrel;
a point subassembly slidably mounted to the actuator subassembly and having a point (11) with a shoulder (11a) adapted to engage a step in the pen when an end of the point projects from a writing end of the pen, the point also having a channel with an open end for receiving the writing tip of a lead in the point subassembly, the point subassembly including a point bushing (12) for frictionally engaging lead (10) in the point subassembly to allow but resist axial relative movement between the lead and the point subassembly;
a point spring (18) engaged between the actuator subassembly and the point subassembly for biasing the point subassembly forwardly and the actuator subassembly rearwardly in the pen;
an actuator insert (15) frictionally engaged to and slidable with respect to the point subassembly; and
a clutch (13) connected to the actuator subassembly and slidably mounted with respect to the point subassembly, the clutch including a plurality of resilient fingers (13a) for receiving lead, each finger having an inclined surface (13b), the actuator insert (15) being engageable along the inclined surfaces for closing the fingers and engage lead in the clutch to fix the lead with respect to the clutch so that further forward movement of the actuator subassembly projects a writing tip of the lead from the open end of the point while the shoulder is engaged against the step to fix the writing tip in a writing position and compete a lead feeding cycle, the clutch fingers each having a stop for engaging the actuator insert (15) for axial movement of the actuator insert rearwardly with rearward movement of the clutch;
the actuator subassembly being movable rearwardly for releasing the actuator insert from the inclined surfaces to release the clutch fingers from the lead and allow the clutch to move rearwardly in the pen, the lead being frictionally held by the point bushing but being moveable into the point by pressure exerted again the frictional holding, continued rearward movement of the actuator subassembly causing engagement of the stops with the actuator insert for causing rearward movement of the actuator insert with respect to the point subassembly and the lead that is frictionally held by the point bushing, to allow for a repeat of the lead feeding cycle.

10. The pencil mechanism of claim 9, including a body assembly connected to an end of the tube of the actuator subassembly that is opposite for the point, the body assembly including an eraser holder fixed to the tube and adapted to receive an eraser, and a pencil top slidably connected to the eraser holder and including a thread adapted for connecting the pencil mechanism to the shuttle of the pen, the body assembly also including a top spring for biasing the eraser holder rearwardly so that pressing forwardly on the eraser holder moved the tube forwardly against the bias of the top spring to cause a lead feeding cycle without rotation of the driver.

11. The pencil mechanism of claim 9, wherein the actuator insert (15) includes a drag bushing (14) for frictionally engaging the point subassembly 11, 17) to resist sliding between the clutch and point subassemblies but by an amount that is less than a bias of the point spring so that when the clutch is moved rearwardly the actuator insert slides rearwardly with respect to the point subassembly.

12. The pencil mechanism of claim 9, wherein the inclined surfaces face the actuator insert, the actuator insert being of low friction material for engaging and sliding along the inclined surfaces to close and open the clutch fingers on the lead.

13. The pencil mechanism of claim 9, including a body assembly connected to an end of the tube of the actuator subassembly that is opposite for the point, the body assembly including an eraser holder fixed to the tube and adapted to receive an eraser, and a pencil top slidably connected to the eraser holder and including a thread adapted for connecting the pencil mechanism to the shuttle of the pen, the body assembly also including a top spring for biasing the eraser holder rearwardly so that pressing forwardly on the eraser holder moved the tube forwardly against the bias of the top spring to cause a lead feeding cycle without rotation of the driver, the actuator insert (15) including a drag bushing (14) for frictionally engaging the point subassembly to resist sliding between the actuator insert and the point subassemblies but by an amount that is less than a bias of the point spring so that when the clutch is moved rearwardly the actuator insert slides rearwardly with respect to the point subassembly and wherein the clutch includes the plurality of inclined surfaces facing the actuator insert, the actuator insert being of low friction material for engaging and sliding along the inclined surfaces to close and open the clutch fingers on the lead.

14. A pencil mechanism for replacing a pen refill in a pen having a driver (107) rotatably connected to a barrel (106) for moving a shuttle (108) axially in the barrel, the barrel having an open writing end with a step (102a) near the open writing end, the pencil mechanism comprising:
an actuator subassembly (15, 16, 19, 21) including hollow tube (21) for containing at least one lead (10) having a writing tip, the tube being adapted to be connected to the shuttle (108) for axial movement in the pen when the driver (107) is rotated with respect to the barrel (106);
a point subassembly (11, 12, 17) slidably mounted to the actuator subassembly and having a point (11) with a shoulder (11a) adapted to engage the step (102a) when an end of the point (11) projects from the writing end of the pen, the point also having a channel with an open end for receiving the writing tip of a lead (10) in the point subassembly, the point subassembly including a point bushing (12) for frictionally engaging lead (10) in the point subassembly to allow but resist axial relative movement between the lead and the point subassembly;
a point spring (18) engaged between the actuator subassembly and the point subassembly for biasing the point subassembly forwardly and the actuator subassembly rearwardly in the pen; and
a clutch subassembly (13, 14, 20) slidably mounted to the actuator subassembly and to the point subassembly, the clutch subassembly including a clutch (13) with plurality of resilient fingers (13a) for receiving lead (10), the actuator subassembly including an actuator (16) for engaging the clutch (13) when the clutch subassembly is moved forwardly by rotation of the driver (107) in a first direction, to close the fingers (13a) and engage lead (10) in the clutch to fix the lead with respect to the clutch so that further forward movement of the actuator subassembly projects a writing tip of the lead from the open end of the point while the shoulder (11a) is engaged against the step (102a) to fix the writing tip in a writing position and compete a lead feeding cycle, the clutch subassembly having a clutch adaptor (20) opposite from the clutch fingers and engageable against the actuator subassembly for restricting relative axial movement between the actuator and the clutch subassemblies;
the actuator subassembly (15, 16, 21) being movable rearwardly in the pen by rotation of the driver (107) in an opposite second direction for releasing the actuator (16) from the clutch (13) to release the clutch fingers (13a) from the lead (10) and allow the clutch subassembly to move rearwardly in the pen, the lead being frictionally held by the point bushing (12) but being moveable into the point (11) by pressure exerted again the frictional holding, continued rearward movement of the actuator subassembly causing engagement with the clutch adaptor (20) for causing rearward movement of the clutch subassembly with respect to the point subassembly and the lead that is frictionally held by the point bushing, to allow for a repeat of the lead feeding cycle.

15. The pencil mechanism of claim 14, wherein the clutch subassembly includes a drag bushing (14) for frictionally engaging the point subassembly to resist sliding between the clutch and point subassemblies but by an amount that is less than a bias of the point spring (18) so that when the clutch subassembly is moved rearwardly it slides rearwardly with respect to the point subassembly.

16. The pencil mechanism of claim 14, wherein the clutch (13) includes a plurality of inclined surfaces (13b) facing the actuator (16), the actuator subassembly including an insert (15) of low friction material connected to the actuator (16) for engaging and sliding along the inclined surfaces to close and open the clutch fingers (13a) on the lead.

17. The pencil mechanism of claim 14, wherein the clutch subassembly includes a drag bushing (14) for frictionally engaging the point subassembly to resist sliding between the clutch and point subassemblies but by an amount that is less than a bias of the point spring (18) so that when the clutch subassembly is moved rearwardly it slides rearwardly with respect to the point subassembly, the clutch (13) including a plurality of inclined surfaces (13b) facing the actuator (16), the actuator subassembly including an insert (15) of low friction material connected to the actuator (16) for engaging and sliding along the inclined surfaces to close and open the clutch fingers (13a) on the lead.

18. The pencil mechanism of claim 14, including a body assembly (2) connected to an end of the tube (21) of the actuator subassembly that is opposite for the point (11), the body assembly including an eraser holder (24) fixed to the tube (21) and adapted to receive an eraser (26), and a pencil top (22) slidably connected to the eraser holder (24) and including a thread (22a) adapted for connecting the pencil mechanism to the shuttle (108) of the pen, the body assembly (2) also including a top spring (23) for biasing the eraser holder rearwardly so that pressing forwardly on the eraser holder moved the tube (21) forwardly against the bias of the top spring (23) to cause a lead feeding cycle without rotation of the driver (107).

19. The pencil mechanism of claim 14, including a body assembly (2) connected to an end of the tube (21) of the actuator subassembly that is opposite for the point (11), the body assembly including an eraser holder (24) fixed to the tube (21) and adapted to receive an eraser (26), and a pencil top (22) slidably connected to the eraser holder (24) and including a thread (22a) adapted for connecting the pencil mechanism to the shuttle (108) of the pen, the body assembly (2) also including a top spring (23) for biasing the eraser holder rearwardly so that pressing forwardly on the eraser holder moved the tube (21) forwardly against the bias of the top spring (23) to cause a lead feeding cycle without rotation of the driver (107), and wherein the clutch subassembly includes a drag bushing (14) for frictionally engaging the point subassembly to resist sliding between the clutch and point subassemblies but by an amount that is less than a bias of the point spring (18) so that when the clutch subassembly is moved rearwardly it slides rearwardly with respect to the point subassembly, the clutch (13) including a plurality of inclined surfaces (13b) facing the actuator (16), the actuator subassembly including an insert (15) of low friction material connected to the actuator (16) for engaging and sliding along the inclined surfaces to close and open the clutch fingers (13a) on the lead.

20. The pencil mechanism of claim 14, including a body assembly (2) connected to an end of the tube (21) of the actuator subassembly that is opposite for the point, the body assembly including an eraser holder (24) fixed to the tube and adapted to receive an eraser, and a pencil top slidably (22) connected to the eraser holder and including a thread adapted for connecting the pencil mechanism to the shuttle of the pen, the body assembly also including a top spring (23) for biasing the eraser holder rearwardly so that pressing forwardly on the eraser holder moved the tube forwardly against the bias of the top spring to cause a lead feeding cycle without rotation of the driver.
